(19) United States
(12) Patent Application Publication
(10) Pub. No.: US 2023/0134223 A1
(43) Pub. Date: May 4, 2023

(54) METHOD AND SYSTEM FOR LARGE SCALE CATEGORIZATION OF WEBSITE COOKIES

(71) Applicant: Michael Busha, Menlo Park, CA (US)

(72) Inventors: Michael Busha, Menlo Park, CA (US); Xiaolin Wang, San Jose, CA (US); Michael Rinehart, Pleasanton, CA (US)

(21) Appl. No.: 18/051,535

(22) Filed: Nov. 1, 2022

Related U.S. Application Data
(60) Provisional application No. 63/274,373, filed on Nov. 1, 2021.

(51) Int. Cl. G06N 20/20

(52) U.S. Cl. CPC G06N 20/20

(57) ABSTRACT

A system and method for large scale categorization of website cookies is disclosed. The method includes gathering information about cookies from a first and second source. The cookies include complex and discrete features. The method includes populating the cookies into a first and second table. The method includes subjecting the first and second table to a machine learning technique to recognize and determine the features. The machine learning technique is operable to convert the complex features into discrete features, wherein the discrete features are set by using at least one of external datasets and embedding the complex features; embed the cookies, wherein a classifier is built as an output of embedding of the cookies; and create a model by using ensembling learning. The method includes categorizing the cookies into a third table and a fourth table. The method includes merging the third and fourth table.

### EARLIEST PRIORITY DATE

This Application claims priority from a Provisional patent application filed in the United States of America having Patent Application No. 63/274,373, filed on Nov. 1, 2021, and titled “LARGE SCALE CATEGORIZATION OF WEBSITE COOKIES.”

### FIELD OF INVENTION

Embodiments of the present disclosure relate to the field of management of cookies, and more particularly to a method and system for large scale categorization of website cookies.

### BACKGROUND

Digital and internet world comprises of exhaustive types of data that also includes personal information. In today's competitive digital world, to enable innovative solutions and improvement in existing services for customers, the exhaustive personal data is collected, stored and coupled with emerging techniques of big data and analytics to performing analytics, market decisions, and research. The personal data can be collected from the digital internet by several ways, of which cookies are most popular.

A cookie (called an Internet or Web cookie) is a piece of data from a website that is stored within a web browser that the website can retrieve at a later time. Cookies are used to tell the server that users have returned to a particular website. This is done so that when users revisit sites, any information that was provided in a previous session or any set preferences can be easily retrieved. Further, the site allows to display selected settings and targeted content based on the information from the cookies. Cookies also store information such as shopping cart contents, registration or login credentials, and user preferences.

There is a large and ever-growing collection of cookies across websites on the Internet. Categorizing of cookies based on their purpose (for instance, essential, functional/performance, advertising) is essential for websites to meet privacy regulations regarding the collection of consumer and user data. For example, websites offer tools allowing visitors to enable or disable cookies by category on their respective websites. However, manual categorization of cookies is a tedious job. One method to categorize cookies involves including specific patterns in the cookie names. However, such patterns are challenging to encode with a manual set of rules.

Hence, there is a need for an improved system and method for which addresses the aforementioned issue(s).

### BRIEF DESCRIPTION

In accordance with an embodiment of the present disclosure, a system for large scale categorization of cookies is provided. The system includes a processing subsystem hosted on a server and configured to execute on a network to control bidirectional communications among a plurality of modules. The processing subsystem includes a collecting module operatively coupled to an integrated database, wherein the collecting module is configured to gather information about a plurality of cookies from a first source and a second source wherein the plurality of cookies comprises a plurality of features wherein the features comprise a combination of complex features and discrete features. Further, the processing subsystem includes a populating module operatively coupled to the collecting module, wherein the populating module is configured to populate the plurality of cookies into a first table and a second table corresponding to the first source and the second source respectively wherein the first source comprises of a plurality of lists and the second source comprises of a plurality of websites. Furthermore, the processing subsystem includes a machine learning module operatively coupled to the populating module, wherein the machine learning module is configured to recognize and determine the features with one or more distinct machine learning techniques. The machine learning module includes a complex feature reduction module configured to convert the one or more complex features of the plurality of cookies into corresponding discrete features, wherein the discrete features are set by using at least one of external datasets and embedding the one or more complex features. Further, the machine learning module includes a cookie reduction module configured to embed the plurality of cookies, upon converting the one or more complex features into corresponding discrete features, wherein a classifier is built as an output of embedding of the plurality of cookies, wherein the classifier is defined as a feature. Furthermore, the machine learning module includes an ensembling module configured to create a model by using ensembling learning with inputs comprising the reduced-dimensionality output and the actual values of the one or more discrete features. Moreover, the processing subsystem includes a predicting module operatively coupled to the machine learning module wherein the predicting module is configured to predict the categorization of the plurality of cookies, through the one or more machine learning techniques, into a plurality of classes based on a threshold wherein the plurality of cookies is populated into a third table and a fourth table corresponding to the first source and second source respectively. The processing subsystem includes a merging module operatively coupled to the predicting module wherein the merging module is configured to merge the plurality of classes from the third table and the fourth table, upon prediction, with precedence to manually categorized cookies and subsequently storing the third table and the fourth table, upon merging, into a fifth table.

In accordance with an embodiment of the present disclosure, a method for large scale categorization of cookies is provided. The method includes gathering information about a plurality of cookies from a first source and a second source wherein the plurality of cookies comprises a plurality of features wherein the features comprise a combination of complex features and discrete features. The method also includes populating the plurality of cookies into a first table and a second table corresponding to the first source and the second source respectively wherein the first source comprises of a plurality of lists and the second source comprises of a plurality of websites. Further, the method includes subjecting the first table and the second table to a machine learning technique to recognize and determine the features. The machine learning technique is operable to convert the one or more complex features of the plurality of cookies into corresponding discrete features, wherein the discrete features are set by using at least one of external datasets and embedding the one or more complex features; embed the plurality of cookies, upon converting the one or more complex features into corresponding discrete features, wherein a classifier is built as an output of embedding of the plurality of cookies, wherein the classifier is defined as a feature; and create a model by using ensembling learning with inputs comprising the reduced-dimensionality output and the actual values of the one or more discrete features. The method includes predicting the categorization of the plurality of cookies, through the machine learning technique, into a plurality of classes based on a threshold wherein the plurality of cookies is populated into a third table and a fourth table corresponding to the first source and second source respectively.

In accordance with an embodiment of the present disclosure, a non-transitory computer-readable medium storing a computer program that, when executed by a processor, causes the processor to perform a method to identify cyber threat intelligence from a group of information is provided. The method includes gathering information about a plurality of cookies from a first source and a second source wherein the plurality of cookies comprises a plurality of features wherein the features comprise a combination of complex features and discrete features. The method also includes populating the plurality of cookies into a first table and a second table corresponding to the first source and the second source respectively wherein the first source comprises of a plurality of lists and the second source comprises of a plurality of websites. Further, the method includes subjecting the first table and the second table to a machine learning technique to recognize and determine the features. The machine learning technique is operable to convert the one or more complex features of the plurality of cookies into corresponding discrete features, wherein the discrete features are set by using at least one of external datasets and embedding the one or more complex features; embed the plurality of cookies, upon converting the one or more complex features into corresponding discrete features, wherein a classifier is built as an output of embedding of the plurality of cookies, wherein the classifier is defined as a feature; and create a model by using ensembling learning with inputs comprising the reduced-dimensionality output and the actual values of the one or more discrete features. The method includes predicting the categorization of the plurality of cookies, through the machine learning technique, into a plurality of classes based on a threshold wherein the plurality of cookies is populated into a third table and a fourth table corresponding to the first source and second source respectively.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representation of a system for large scale categorization of website cookies in accordance with an embodiment of the present disclosure;

FIG. 2 a block diagram representation of a machine learning module of FIG. 1 in accordance with an embodiment of the present disclosure;

FIG. 3 is a schematic representation of an environment for large scale categorization of website cookies in accordance with an embodiment of the present disclosure;

FIG. 4 is a block diagram of a computer or a server in accordance with an embodiment of the present disclosure;

FIG. 5 (a) illustrates a flow chart representing the steps involved in a method for large scale categorization of website cookies in accordance with an embodiment of the present disclosure; and

FIG. 5 (b) illustrates continued steps of the method of FIG. 5 (a) in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or subsystems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to system and a method for large scale categorization of website cookies. The system includes a processing subsystem hosted on a server and configured to execute on a network to control bidirectional communications among a plurality of modules. The processing subsystem includes a collecting module operatively coupled to an integrated database, wherein the collecting module is configured to gather information about a plurality of cookies from a first source and a second source wherein the plurality of cookies comprises a plurality of features wherein the features comprise a combination of complex features and discrete features. Further, the processing subsystem includes a populating module operatively coupled to the collecting module, wherein the populating module is configured to populate the plurality of cookies into a first table and a second table corresponding to the first source and the second source respectively wherein the first source comprises of a plurality of lists and the second source comprises of a plurality of websites. Furthermore, the processing subsystem includes a machine learning module operatively coupled to the populating module, wherein the machine learning module is configured to recognize and determine the features with one or more distinct machine learning techniques. The machine learning module includes a complex feature reduction module configured to convert the one or more complex features of the plurality of cookies into corresponding discrete features, wherein the discrete features are set by using at least one of external datasets and embedding the one or more complex features. Further, the machine learning module includes a cookie reduction module configured to embed the plurality of cookies, upon converting the one or more complex features into corresponding discrete features, wherein a classifier is built as an output of embedding of the plurality of cookies, wherein the classifier is defined as a feature. Furthermore, the machine learning module includes an ensembling module configured to create a model by using ensembling learning with inputs comprising the reduced-dimensionality output and the actual values of the one or more discrete features. Moreover, the processing subsystem includes a predicting module operatively coupled to the machine learning module wherein the predicting module is configured to predict the categorization of the plurality of cookies, through the one or more machine learning techniques, into a plurality of classes based on a threshold wherein the plurality of cookies is populated into a third table and a fourth table corresponding to the first source and second source respectively. The processing subsystem includes a merging module operatively coupled to the predicting module wherein the merging module is configured to merge the plurality of classes from the third table and the fourth table, upon prediction, with precedence to manually categorized cookies and subsequently storing the third table and the fourth table, upon merging, into a fifth table.

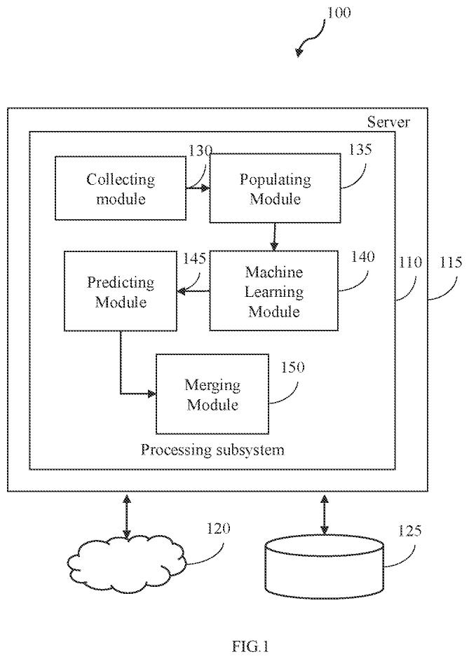

FIG. 1 is a block diagram representation of a system 100 for large scale categorization of website cookies in accordance with an embodiment of the present disclosure. The system 100 includes a processing subsystem 110. The processing subsystem 110 is hosted on a server 115. In one embodiment, the server 115 may be a cloud-based server. In another embodiment, the server 115 may be a local server. The processing subsystem 110 is configured to execute on a network 120 to control bidirectional communications among a plurality of modules. In one embodiment, the network 120 may include one or more terrestrial and/or satellite networks interconnected to communicatively connect a user device to web server engine and a web crawler. In one example, the network 120 may be a private or public local area network (LAN) or wide area network, such as the internet.

Moreover, in another embodiment, the network 120 may include both wired and wireless communications according to one or more standards and/or via one or more transport mediums. In one example, the network 120 may include wireless communications according to one of the 802.11 or Bluetooth specification sets, LoRa (Long Range Radio) or another standard or proprietary wireless communication protocol. In yet another embodiment, the network 120 may also include communications over a terrestrial cellular network, including, a GSM (global system for mobile communications), CDMA (code division multiple access), and/or EDGE (enhanced data for global evolution) network.

Further, the processing subsystem 110 includes a collecting module 130 operatively coupled to an integrated database 125. In one embodiment, the integrated database 125 may include, but not limited to, an SQL database, a non-SQL database, a hierarchical database, a columnar database and the like. In one embodiment, the data stored in the integrated database 125 and can be used for several applications. In yet another embodiment, the details for a plurality of cookies such as cookie name, a category, a purpose, a consent and so on is saved in the integrated database 125. The collecting module 130 is configured to to gather information about a plurality of cookies from a first source and a second source wherein the plurality of cookies comprises a plurality of features. Further, the features comprise a combination of complex features and discrete features. In one embodiment, the first source is a plurality of lists in the system 100 and the second source are customer websites. As used herein, the plurality of cookies may include, first-party cookies, third-party cookies, website cookies, session cookies, persistent cookies, secure cookies and the like. Common use cases of cookies include session management, personalization and tracking. Specifically, for the purpose of the disclosed system and method, the plurality of cookies refers to website cookies.

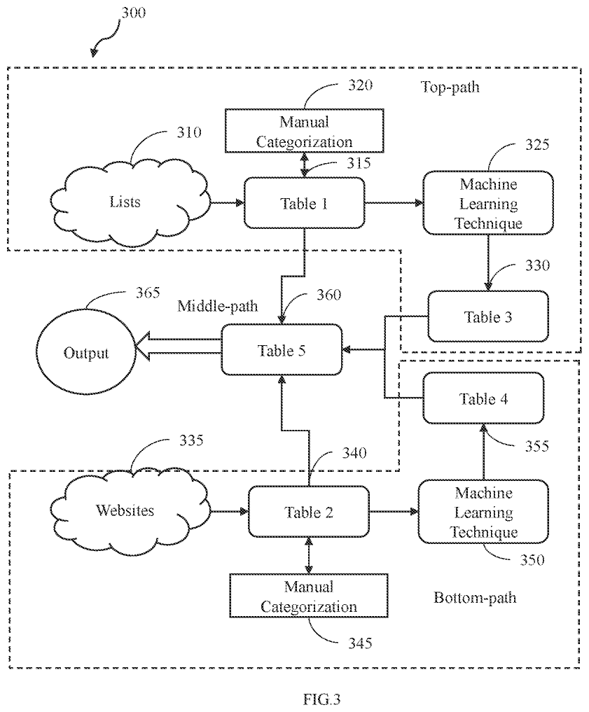

Further, the processing subsystem 110 includes a populating module 135 operatively coupled to the collecting module 130. The populating module 135 is configured to populate the plurality of cookies into a first table and a second table corresponding to the first source and the second source respectively. As mentioned earlier, the first source comprises of a plurality of lists and the second source comprises of a plurality of websites. The populating module 135 is also configured to populate a third table and fourth table that is further discussed in FIG. 3.

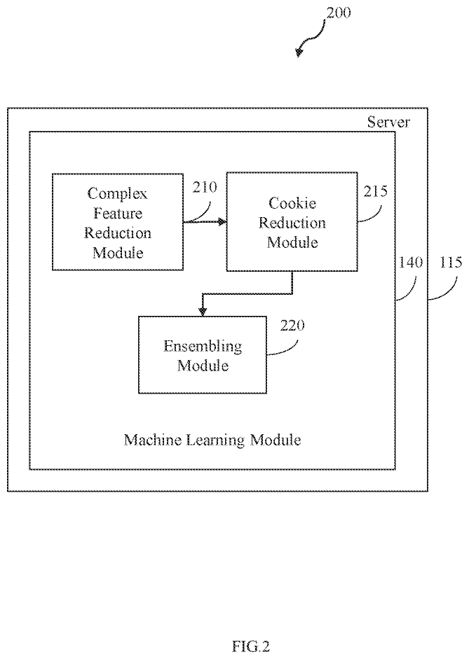

Furthermore, the processing subsystem 110 includes a Machine Learning Module 140 operatively coupled to the populating module 135. The Machine Learning Module 140 is configured to recognize and determine the features with one or more machine learning techniques. The one or more machine learning techniques may include, but not limited to, linear regression, logistic regression, decision tree, SVM technique, naive bayes technique, KNN technique, K-means, random forest technique, and the like. In a specific embodiment and for the purpose of the disclosed system and method, the two machine learning techniques used are Ensemble Deep Learning and End-to-End Deep Learning. The Machine Learning Module is further explained in conjunction with the FIG. 2.

Moreover, the processing subsystem 110 includes a predicting module 145 operatively coupled to the Machine Learning Module 140. The predicting module 145 is configured to predict the categorization of the plurality of cookies, through the machine learning technique, into a plurality of classes based on a threshold wherein the plurality of cookies is populated into a third table and a fourth table corresponding to the first source and second source respectively.

The processing subsystem 110 also includes a merging module 150 operatively coupled to the predicting module 145. The merging module 150 is configured to merge the plurality of classes from the third table and the fourth table, upon prediction, with precedence to manually categorized cookies and subsequently storing the third table and the fourth table, upon merging, into a fifth table.

FIG. 2 a block diagram representation of a machine learning module of FIG. 1 in accordance with an embodiment of the present disclosure. Typically, the machine learning module 140 is trained by machine learning techniques/algorithms to categorize the website cookies. The machine learning module 140 further comprises a complex feature reduction module 210, a cookie reduction module 215 and an ensembling module 220.

The complex feature reduction module 210 is configured to convert the one or more complex features of the plurality of cookies into corresponding discrete features, wherein the discrete features are set by using at least one of external datasets and embedding the one or more complex features.

The cookie reduction module 215 is configured to embed the plurality of cookies, upon converting the one or more complex features into corresponding discrete features, wherein a classifier is built as an output of embedding of the plurality of cookies, wherein the classifier is defined as a feature.

The ensembling module 220 is configured to create a model by using ensembling learning with inputs comprising the reduced-dimensionality output and the actual values of the one or more discrete features.

FIG. 3 is a schematic representation of an environment 300 for large scale categorization of website cookies in accordance with an embodiment of the present disclosure. The environment 300 may be referred to as a technical framework of the method and system disclosed herein.

The framework 300 describes a top-path, a bottom-path and a middle-path. The top-path begins by discovering information of website cookies (cookie names) through a plurality of lists of cookies 310 from cookie policy pages or feedback from customers who visit a plurality of websites. A part of the information may be available (such as the host) and may not be discovered if they were not seen with a web browser. Upon gathering such information, the missing data is treated as NaN. The information gathered is written in a table namely ‘Table 1’ 315. In one embodiment, a part of the cookies that are gathered are manually categorized by researchers 320. In such an embodiment, the results are saved into the Table 1.

Additionally, a machine learning technique (algorithm) is applied to Table 1 325. It is the objective of the machine learning algorithm to learn the relationship between the features of the website cookies and the categories. Upon learning the relationship, the machine learning algorithm categorizes the website cookies as much as possible with a high precision. It must be noted that some cookies may be left uncategorized at this time. The results of the categorization performed by the machine learning algorithm is written into ‘Table 3’ 330. Therefore, it should be noted that Table 3 330 completes the ‘top-path’.

Now referring to the ‘bottom-path’ of the framework. The bottom-path typically focusses on the information gathered from websites 335. The information is gathered either by crawling sites or by crawling the websites with a special plugin by a worker of the system disclosed herein. All the information is gathered and written (populated) into ‘Table 2’ 340. A part of the cookies gathered are manually categorized however there may be cookies that are not categorized as well 345. Such uncategorized cookies are also saved in Table 2 340. Subsequently, a machine learning algorithm 350 is applied to Table 2 that is operable to understand the relationship between the features and the categories. The results are subsequently written into Table 4. Therefore, it should be noted that Table 4 355 completes the ‘bottom-path’.

In one embodiment, the machine learning algorithms used for Table 1 and Table 2, once trained, may also be applied to cookies gathered from an arbitrary source (for instance, list, website and the like) for the purposes of making predictions (if the cookies include the appropriate features). Two distinct machine learning algorithms may be used for training purposes and, generally, for predicting missing categories for cookies in Table 1 and Table 2. Additionally, cookies may be gathered from a different source when it is an online mode of predication. In such a scenario, the cookies will flow through one or both the paths (namely top-path and bottom-path) based on the cookie features. This is an additional form of ensembling.

It is to be noted that Table 3 330 and Table 4 355 comprises the category predictions of the website cookies by the machine learning algorithms. Further, the said categories are merged to present an output 365 as ‘Table 5’ 360. The Comma-Separated Values (CSV) files are merged with precedent given to the manually categorized cookies into Table 5 360. Typically, the CSV files are a specific format used for machine learning algorithms. In one embodiment, the cookies may be processed by both the ‘top-path’ and ‘bottom-path’. In such an embodiment, ensembling may be implemented to set the final categorization of the said cookies in Table 5 360.

In one embodiment, the framework 300 supports online categorization of the website cookies. In such an embodiment, the machine learning algorithm used in the bottom-path of the framework 300 is used to categorize the cookies. Consequently, latency between the discovery of the website cookies and its categorization may be reduced. These website cookies are typically discovered on the websites (customer websites) during scanning. It must be noted that some of these cookies are not categorized in Table 5.

Further, it must be noted that the type of data, amount of missing data, and the data distribution between the top-path and the bottom-path seem to vary. Therefore, a single machine learning model cannot be trained for both the paths.

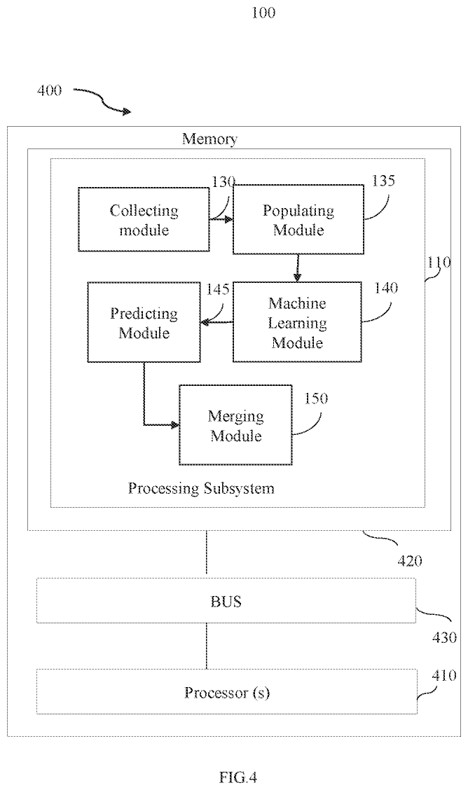

FIG. 4 is a block diagram of a computer or a server in accordance with an embodiment of the present disclosure. The server 400 includes processor(s) 410, and memory 420 operatively coupled to the bus 430. The processor(s) 410, as used herein, includes any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 420 includes several subsystems stored in the form of computer-readable medium which instructs the processor to perform the method steps illustrated in FIG. 1. The memory 420 is substantially similar to system 100 of FIG. 1. The memory 420 has the following subsystems: the processing subsystem 110 including the collecting module 130, a populating module 135, a machine learning module 140, a predicting module 145 and a merging module 150. The plurality of modules of the processing subsystem 110 performs the functions as stated in FIG. 1 and FIG. 2. The bus 430 as used herein refers to be the internal memory channels or computer network that is used to connect computer components and transfer data between them. The bus 430 includes a serial bus or a parallel bus, wherein the serial bus transmit data in bit-serial format and the parallel bus transmit data across multiple wires. The bus 430 as used herein, may include but not limited to, a system bus, an internal bus, an external bus, an expansion bus, a frontside bus, a backside bus, and the like.

While computer-readable medium is shown in an example embodiment to be a single medium, the term “computer-readable medium” should be taken to include a single medium or multiple media (for example, a centralized or distributed database, or associated caches and servers) able to store the instructions. The term “computer readable medium” shall also be taken to include any medium that is capable of storing instructions for execution by the machine and that cause the machine to perform any one or more of the methodologies disclosed herein. The term “computer-readable medium” includes, but not to be limited to, data repositories in the form of solid-state memories, optical media, and magnetic media.

The system includes a processing subsystem 110 hosted on a server 115 and configured to execute on a network 120 to control bidirectional communications among a plurality of modules. The processing subsystem 110 includes a collecting module 130 operatively coupled to an integrated database 125, wherein the collecting module 130 is configured to gather information about a plurality of cookies from a first source and a second source wherein the plurality of cookies comprises a plurality of features wherein the features comprise a combination of complex features and discrete features. Further, the processing subsystem 110 includes a populating module 135 operatively coupled to the collecting module 130, wherein the populating module 135 is configured to populate the plurality of cookies into a first table and a second table corresponding to the first source and the second source respectively wherein the first source comprises of a plurality of lists and the second source comprises of a plurality of websites. Furthermore, the processing subsystem 110 includes a machine learning module 140 operatively coupled to the populating module 135, wherein the machine learning module 140 is configured to recognize and determine the features with one or more distinct machine learning techniques. The machine learning module 140 includes a complex feature reduction module 210 configured to convert the one or more complex features of the plurality of cookies into corresponding discrete features, wherein the discrete features are set by using at least one of external datasets and embedding the one or more complex features. Further, the machine learning module 140 includes a cookie reduction module 215 configured to embed the plurality of cookies, upon converting the one or more complex features into corresponding discrete features, wherein a classifier is built as an output of embedding of the plurality of cookies, wherein the classifier is defined as a feature. Furthermore, the machine learning module 140 includes an ensembling module 220 configured to create a model by using ensembling learning with inputs comprising the reduced-dimensionality output and the actual values of the one or more discrete features. Moreover, the processing subsystem 110 includes a predicting module 145 operatively coupled to the machine learning module 140 wherein the predicting module 145 is configured to predict the categorization of the plurality of cookies, through the machine learning technique, into a plurality of classes based on a threshold wherein the plurality of cookies is populated into a third table and a fourth table corresponding to the first source and second source respectively. The processing subsystem 110 includes a merging module 150 operatively coupled to the predicting module 145 wherein the merging module 150 is configured to merge the plurality of classes from the third table and the fourth table, upon prediction, with precedence to manually categorized cookies and subsequently storing the third table and the fourth table, upon merging, into a fifth table.

Computer memory elements may include any suitable memory device(s) for storing data and executable program, such as read only memory, random access memory, erasable programmable read only memory, electrically erasable programmable read only memory, hard drive, removable media drive for handling memory cards and the like. Embodiments of the present subject matter may be implemented in conjunction with program modules, including functions, procedures, data structures, and application programs, for performing tasks, or defining abstract data types or low-level hardware contexts. Executable program stored on any of the above-mentioned storage media may be executable by the processor(s) 410.

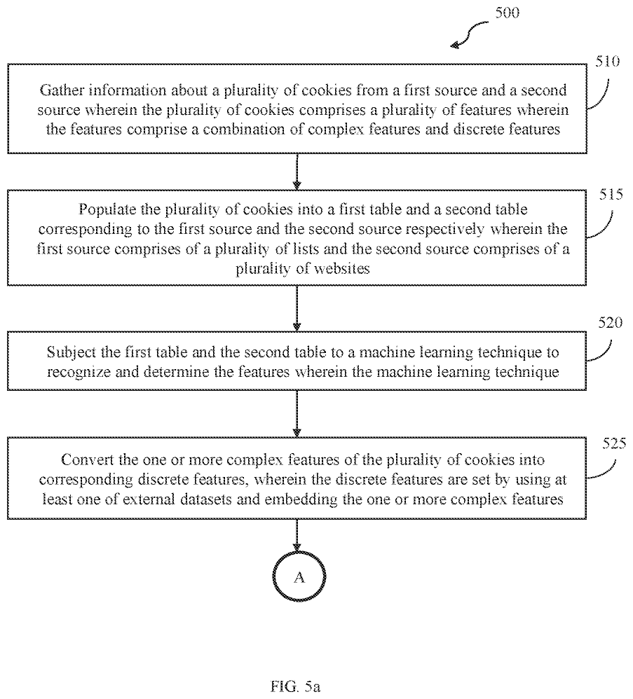

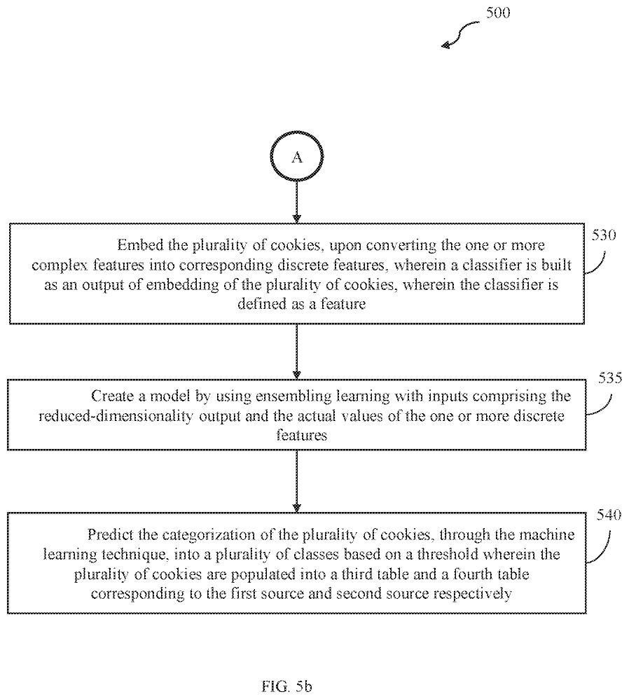

FIG. 5 (a) illustrates a flow chart representing the steps involved in a method 500 for large scale categorization of website cookies in accordance with an embodiment of the present disclosure. FIG. 5 (b) illustrates continued steps of the method 500 of FIG. 5 (a) in accordance with an embodiment of the present disclosure.

The method disclosed herein may be applied to both 3^{rd} and 1^{st} party website cookies and with variants for both online and offline classification. The method 500 starts at step 510.

At step 510, information about a plurality of cookies is gathered from a first source and a second source. Typically, the first source refers to a plurality of lists within the system disclosed herein whereas the second source refers to a plurality of websites. Further, the plurality of cookies includes a plurality of features wherein the features comprise a combination of complex features and discrete features. Further, the features may be labelled data and/or unlabeled data.

The information about the plurality of cookies is automatically retrieved from the second source by crawling the websites with a special plugin and subsequently storing the said information in the second table.

The table below describes the type of cookie data and metadata that may be used for the machine learning algorithm for cookie categorization.

TABLE 1
illustrates the information of website cookies, the source of the website cookies, features
of the website cookies and whether the website cookies need to be trained with missing values
using a machine language algorithm.

| | | Where Is It | May Need to Train |
|---|---|---|---|
| Information | Exemplary Features | Sourced? | with missing values? |
| site name | | cookie | N |
| | embedding from chars | | |
| | or common crawl | | |
| | word vectors | | |
| Host | | cookie | Y—may encounter |
| | | | new domains |
| | embedding from chars | | |
| cookie name | | cookie | N |
| | special vatterns | | |
| | n-gram | | |
| | embedding from chars | | |
| | from cookie names | | |
| cookie host | | cookie | N |
| | embedding from chars | | |
| is_first_party | | cookie | N |
| | binary | | |
| collected at | Y | collection SW | N |
| | int (UTC) | | |
| Expiry | | cookie | N |
| | int | | |
| is_http_only | | cookie | N |
| | binary | | |
| is_session_cookie | | cookie | N |
| | binary | | |
| is_secure | | cookie | N |
| | binary | | |
| country | | ip address + list | Y |
| | enumeration | | |
| | word vector | | |
| | does it change from | | |
| | scan-to-scan (multi- | | |
| | scan) | | |
| cookie size | | cookie | N |
| | int | | |
| cookie value | | cookie | N |
| | char level embedding | | |
| | from lots of cookies | | |
| | compressibility = | | |
| | degree of randomness | | |
| | changes on each visit | | |
| | (multi-scan) | | |
| | changes as site are | | |
| | crawled (multi-scan) | | |
| | varies with browser | | |
| | (multi-scan) | | |
| | varies with time | | |
| | (multi-scan) | | |
| | varies with browser ip | | |
| | geolocation (multi- | | |
| search results = | | automation | Y—may want to train |
| structured form for | | | directly on it and use |
| top 10 or 20 results | | | its classification as an |
| summaries | | | input |
| contents of pages | | | |
| | tf-idf vectorizer | | |
| | USE | | |
| | BERT variant— | | |
| | different lavers | | |
| Cookie owner | | automation | Y |
| category | | | |
| | Just a look up to a | | |
| | fixed set of categories | | |
| | Leave blank if | | |
| | unknown | | |
| Site owner category | | automation | Y |
| | Just a look up to a | | |
| | fixed set of categories | | |
| | Leave blank if | | |
| | unknown | | |

A few observations may be inferred from the above table as listed below:
a. ‘cookie_name’ may be used as a feature
b. ‘hostname’ may be ignored
c. Hosts that are categorized separately may be considered

At step 515, the plurality of cookies is populated into a first table and a second table corresponding to the first source and the second source respectively wherein the first source comprises of a plurality of lists and the second source comprises of a plurality of websites.

In one embodiment, a portion of the plurality of cookies gathered from the first source and the second source are manually categorized. These cookies are also populated into their respective tables.

In one embodiment, the rate at which information of the website cookies are gathered may exceed the rate at which categories and tables are populated.

At step 520, the first table and the second table are subjected to a machine learning technique to recognize and determine the features wherein the machine learning technique.

Typically, the machine learning technique learns the relationship between the features of the cookies and corresponding categories. The modeling approaches implemented in the machine learning technique is the ensemble deep learning approach and end-to-end deep learning approach. Although the end-to-end deep learning approach is implemented, it must be noted that a preference is likely to be given to the ensemble deep learning approach.

At step 525, the one or more complex features of the plurality of cookies is converted into corresponding discrete features, wherein the discrete features are set by using at least one of external datasets and embedding the one or more complex features.

The features of the website cookies may be simple or complex. Further, the ratio between labeled data and unlabeled data is very low. Therefore, it is essential that a combination of the ensemble deep learning model and a semi-supervised technique is used to enhance the performance of the method discussed herein.

The complex feature reduction is executed on the complex features of the website cookies to convert them into discrete features. In one embodiment, a few of the simple discrete features may be set using external datasets (even though missing values are expected). The other discrete features will first be set by embedding the complex feature. Subsequently, a cookie-category classifier is used on the discrete features. The output of the classifier is used as a feature. Further, all the embeddings are clustered together, and a number is assigned that denotes a discrete cluster number.

Consider a complex feature such as cookie-name. In one embodiment, the cookie_name values are regular expressions representing a plurality of cookie_name values.

The complex features may be embedded by using a suitable approach, for instance, but not limited to, CNN-LSTM autoencoder, Bi-LSTM autoencoder and Character-level transformer. In a specific embodiment, the proposed convolutional neural network (CNN) LSTM autoencoder is an implementation of an autoencoder for sequence data using an Encoder-Decoder LSTM architecture. The autoencoder is a type of self-supervised learning model (neural network model) that can learn a compressed representation of input data.

Another exemplary supervised approach may be implemented as follows:
1. Train a classifier which takes a cookie name and predicts its possibilities for all cookie categories. These possibilities will then act as the input features to the final classifier which takes all the features to understand.
2. Cookie names that have labeled cookie categories are used.
3. The 1-d embeddings of every character in a cookie name are concatenated into a vector and becomes the input to a 1-d CNN based architecture to feature the input vector, followed by a fully connected classification layer.

Further, cookie_name embeddings can be either used directly in other models or they can be used to train a model on their own. The output of such models may be used in final models such as for ensembling. In a preferred embodiment, ensembling is used in the final models. Finally, a cluster number may be assigned if the vectors of the models are clustered.

Consider another complex feature such as a cookie_host. Many cookies share the same cookie_host. Therefore, it is possible to train a machine learning model based on cookie_host and subsequently categorize the said cookies. Most cookie hosts are attached to categories. For instance, Facebook may be categorized as e-commerce and social networking. Therefore, it is essential to leverage the cookie host category. For instance, a sentence encoder may be applied to encode the categories of the cookie hosts and then apply an autoencoder to reduce the dimension of the embeddings. The embeddings are then used as features in the final cookie categorization classifier. Finally, a cluster number may be assigned if the vectors of the models are clustered.

Additionally, a machine learning model may also be trained based on cookie_value and subsequently categorize the said cookies.

Some cookie values may be categorized into timestamps or UIDs, which is flexible. For instance, sometimes cookie names are followed by a UUID/Hash format that may be used for tracking (identify the user and browser), values may be a timestamp or a version number, there may be specific content like an email address, the length and entropy may indicate the total information present and data about the value changes based on time, machine, location may be informative. Finally, a cluster number may be assigned if the vectors of the models are clustered.

The cookie reduction is a process of embedding all the cookies and converting them into a discrete feature. The complex features may be converted by the complex feature reduction. Further, a classifier is built from the embedding and the output of the classifier is used as a feature. In one embodiment, the classifier outputs may be clustered and used as a feature.

It is to be noted that the cookie features in the top-path and bottom-path may be different and therefore an unsupervised model for each dataset may produce effective results. Further, due to the occurrence of unlabeled data, an auto-encoder may be utilized to make cookie vectors that can be used in training. In one embodiment, semi-supervised approaches may be considered as well.

Further, cookie vectors may be discretized by either using classification results or a cookie cluster number.

At step 530, the plurality of cookies is embedded, upon converting the one or more complex features into corresponding discrete features, wherein a classifier is built as an output of embedding of the plurality of cookies. The classifier is defined as a feature.

At step 535, a model is created by using ensembling learning with inputs comprising the reduced-dimensionality output and the actual values of the one or more discrete features.

Ensembling is a process wherein an ensemble model is built by using the reduced outputs of the complex feature reduction and cookie reduction, and the actual values of the simple features.

Upon building the ensemble model, almost all cookies are categorized. The ensemble model's precision for each output class will determine the threshold for classifying that class. This implies that it is possible for one or more cookies to be uncategorized. In one embodiment, if there is an occurrence of a significant gap between the classifier output and the real data, then under such circumstances, the real data may have to be processed again. In such an embodiment, the gap is indicative of a situation in which the real data is different from the training data for the machine learning techniques. Therefore, the real data is augmented and then processed again. This improves the generalizability of the ensemble model.

The ensemble model can access all the reduced features as well as the raw values for all the simple features of the model. As a result, a highly reliable and high-speed classifier model may be created as the ensemble.

Further, the plurality of classes from the third table and the fourth table, upon prediction, are merged together with precedence to manually categorized cookies and subsequently storing the third table and the fourth table, upon merging, into a fifth table. The fifth table comprises the categorization of the cookies and metadata used for subsequent training of the machine learning technique.

At step 540, the categorization of the plurality of cookies is predicted, through the machine learning technique, into a plurality of classes based on a threshold wherein the plurality of cookies is populated into a third table and a fourth table corresponding to the first source and second source respectively.

The method ends at step 540.

Various embodiments of the system and method for large scale categorization of cookies described above enable various advantages. The automated method for categorizing the website cookies eliminates the need of manual categorization. Further, the method and system categories the website cookies at a large scale thereby providing efficacy. Furthermore, the method could be applied on both 3^{rd} party and 1^{st} party cookies and with variants for both online and offline processing. The application of the machine learning techniques helps in identifying issues in the data more effectively and can give insights into effective architectures for certain features.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

I claim:

1. A computer-implemented method for large scale categorization of cookies comprising:
gathering information about a plurality of cookies from a first source and a second source wherein the plurality of cookies comprises a plurality of features wherein the features comprise a combination of complex features and discrete features;
populating the plurality of cookies into a first table and a second table corresponding to the first source and the second source respectively wherein the first source comprises of a plurality of lists and the second source comprises of a plurality of websites;
subjecting the first table and the second table to one or more machine learning techniques to recognize and determine the features wherein the machine learning technique is operable to:
convert the one or more complex features of the plurality of cookies into corresponding discrete features, wherein the discrete features are set by using at least one of external datasets and embedding the one or more complex features;
embed the plurality of cookies, upon converting the one or more complex features into corresponding discrete features, wherein a classifier is built as an output of embedding of the plurality of cookies, wherein the classifier is defined as a feature;
create a model by using ensembling learning with inputs comprising the reduced-dimensionality output and the actual values of the one or more discrete features; and
predicting the categorization of the plurality of cookies, through the machine learning technique, into a plurality of classes based on a threshold wherein the plurality of cookies is populated into a third table and a fourth table corresponding to the first source and second source respectively.

2. The computer-implemented method of claim 1 wherein the plurality of classes from the third table and the fourth table, upon prediction, are merged together with precedence to manually categorized cookies and subsequently storing the third table and the fourth table, upon merging, into a fifth table.

3. The computer-implemented method of claim 1 wherein the information about the plurality of cookies is automatically retrieved from the second source by crawling the websites with a special plugin and subsequently storing the said information in the second table.

4. The computer-implemented method of claim 1 wherein a part of the first table and the second table comprises manually categorized cookies.

5. The computer-implemented method of claim 1 wherein the machine learning technique learns the relationship between the features of the cookies and corresponding categories.

6. The computer-implemented method of claim 2 wherein the fifth table comprises the categorization of the cookies and metadata used for subsequent training of the machine learning technique.

7. The computer-implemented method of claim 1 wherein the plurality of cookies is categorized online and offline.

8. The computer-implemented method of claim 1 wherein the cookies are website cookies.

9. The computer-implemented method of claim 1 wherein the machine learning techniques are Ensemble Deep Learning modelling approach and End-to-End Deep Learning modelling approach.

10. A non-transitory computer-readable medium storing a computer program that, when executed by a processor, causes the processor to perform a method for large scale categorization of cookies, wherein the method comprises:
gathering information about a plurality of cookies from a first source and a second source wherein the plurality of cookies comprises a plurality of features wherein the features comprise a combination of complex features and discrete features;
populating the plurality of cookies into a first table and a second table corresponding to the first source and the second source respectively wherein the first source comprises of a plurality of lists and the second source comprises of a plurality of websites;
subjecting the first table and the second table to one or more machine learning techniques to recognize and determine the features wherein the machine learning technique is operable to:
convert the one or more complex features of the plurality of cookies into corresponding discrete features, wherein the discrete features are set by using at least one of external datasets and embedding the one or more complex features;
embed the plurality of cookies, upon converting the one or more complex features into corresponding discrete features, wherein a classifier is built as an output of embedding of the plurality of cookies, wherein the classifier is defined as a feature;
create a model by using ensembling learning with inputs comprising the reduced-dimensionality output and the actual values of the one or more discrete features; and
predicting the categorization of the plurality of cookies, through the machine learning technique, into a plurality of classes based on a threshold wherein the plurality of cookies is populated into a third table and a fourth table corresponding to the first source and second source respectively.

11. The computer-readable medium of claim 10 wherein the plurality of classes from the third table and the fourth table, upon prediction, are merged together with precedence to manually categorized cookies and subsequently storing the third table and the fourth table, upon merging, into a fifth table.

12. The computer-readable medium of claim 10 wherein the information about the plurality of cookies is automatically retrieved from the second source by crawling the websites with a special plugin and subsequently storing the said information in the second table.

13. The computer-readable medium of claim 10 wherein a part of the first table and the second table comprises manually categorized cookies.

14. The computer-readable medium of claim 10 wherein the machine learning technique learns the relationship between the features of the cookies and corresponding categories.

15. The computer-readable medium of claim 11 wherein the fifth table comprises the categorization of the cookies and metadata used for subsequent training of the machine learning technique.

16. The computer-readable medium of claim 10 wherein the plurality of cookies is categorized online and offline.

17. The computer-readable medium of claim 10 wherein the cookies are website cookies.

18. The computer-readable medium of claim 10 wherein the machine learning techniques are Ensemble Deep Learning modelling approach and End-to-End Deep Learning modelling approach.

19. A system for large scale categorization of cookies comprising:
a processing subsystem hosted on a server and configured to execute on a network to control bidirectional communications among a plurality of modules comprising:
a collecting module operatively coupled to an integrated database, wherein the collecting module is configured to gather information about a plurality of cookies from a first source and a second source wherein the plurality of cookies comprises a plurality of features wherein the features comprise a combination of complex features and discrete features;
a populating module operatively coupled to the collecting module, wherein the populating module is configured to populate the plurality of cookies into a first table and a second table corresponding to the first source and the second source respectively wherein the first source comprises of a plurality of lists and the second source comprises of a plurality of websites;
a machine learning module operatively coupled to the populating module, wherein the machine learning module is configured to recognize and determine the features with one or more machine learning techniques, wherein the machine learning module comprises:
a complex feature reduction module configured to convert the one or more complex features of the plurality of cookies into corresponding discrete features, wherein the discrete features are set by using at least one of external datasets and embedding the one or more complex features;
a cookie reduction module configured to embed the plurality of cookies, upon converting the one or more complex features into corresponding discrete features, wherein a classifier is built as an output of embedding of the plurality of cookies, wherein the classifier is defined as a feature;
an ensembling module configured to create a model by using ensembling learning with inputs comprising the reduced-dimensionality output and the actual values of the one or more discrete features; and
a predicting module operatively coupled to the machine learning module wherein the predicting module is configured to predict the categorization of the plurality of cookies, through the machine learning technique, into a plurality of classes based on a threshold wherein the plurality of cookies is populated into a third table and a fourth table corresponding to the first source and second source respectively.

20. The system as claimed in claim 19 comprising:
a merging module operatively coupled to the predicting module wherein the merging module is configured to merge the plurality of classes from the third table and the fourth table, upon prediction, with precedence to manually categorized cookies and subsequently storing the third table and the fourth table, upon merging, into a fifth table.
